(19) United States
(12) Patent Application Publication
(10) Pub. No.: US 2009/0192850 A1
(43) Pub. Date: Jul. 30, 2009

(54) METHOD FOR SELECTING POSTAL PRODUCTS USING FORMAL POSTAL PRODUCT DEFINITIONS

(75) Inventors: Leon A. Pintsov, West Hartford, CT (US); Andrei Obrea, Seymour, CT (US)

Correspondence Address: PITNEY BOWES INC., 35 WATERVIEW DRIVE, MSC 26-22, SHELTON, CT, 06484-3000, US

(73) Assignee: Pitney Bowes Inc., Stamford, CT (US)

(21) Appl. No.: 12/357,492

(22) Filed: Jan. 22, 2009

Related U.S. Application Data
(60) Provisional application No. 61/023,512, filed on Jan. 25, 2008.

(51) Int. Cl. G06Q 10/00

(52) U.S. Cl. 705/7

(57) ABSTRACT

A computerized method that allows the posts to determine what new products and services their customers want. The foregoing is accomplished by creating an automated process that: collects from mailers a description of new products and services the mailers would like to have and summarizes the description of new products and services in terms of postal products and services that would have a broad appeal.

This Application claims the benefit of the filing date of U.S. Provisional Application No. 61/023,512 filed Jan. 25, 2008, which is owned by the assignee of the present Application.

### FIELD OF THE INVENTION

This invention relates to mailing systems and more particularly to the creation of new postal products and the modification of existing postal products.

### BACKGROUND OF THE INVENTION

Governments have created postal services for collecting, sorting and distributing the mail. It is difficult for government and private postal services to define and supply new services to the public. The postal service produces and performs operations on a physical item called a mail unit and obtains detailed information about operations and supplying this information to end users i.e., senders and recipients. The postal service or post office communicates product features geared to humans not machines. Humans are inefficient to change, machines more readily accept changes.

Traditional postal product like first class and standard mail can be defined and explained in simple terms and therefore end users do not have problems creating mail for first class and standard mail services. With increased sophistication of postal products and associated requirements effective use of new postal products by mailers is hindered by the lack of automation.

In the current economic and political environment many national posts are in competition with other carriers and are having difficulty meeting their operations budget. Therefore many posts would like to become more profitable and supply additional products and services to their customers.

Thus, one of the problems of the prior art is that many posts want to know what new products and services to supply to their customers. Unfortunately the posts have no way of determining what new products and services to offer.

An additional problem of the prior art is that if the posts knew what new products and services to supply to their customers they had no way of determining whether or not the new products and services may be accomplished using the constraints imposed by the posts current network processes and equipment.

### SUMMARY OF THE INVENTION

This invention overcomes the disadvantages of the prior art by creating an automated process that allows the posts to determine what new products and services their customers want and whether or not the new products and services may be accomplished using the constraints imposed by the posts current network processes and equipment. The foregoing is accomplished by creating an automated process that: collects from mailers a description of new products and services the mailers would like to have; summarizes the description of new products and services in terms of postal products and services that would have a broad appeal; and determines the feasibility of new products and services within existing constraints. Alternatively the posts may change or modify existing constraints to offer new products and services.

The invention describes a formal mechanism for defining a broad variety of postal products using measurable attributes. The mechanism for the products then may be formalized into data structures and procedures executable by computer systems.

The postal products from the senders prospective contains physical elements. The physical elements of the mail unit are physical parameters “dimensions, volume, density, material characteristics and content”. Content is restricted for certain services for instance you cannot mail liquids or powders. The physical elements also include the geography of induction, geography of delivery of the mail unit, routing information, i.e., the options for selecting a route between induction and delivery points and timing and frequency of collection and delivery of the mail unit.

The informational elements of the postal product from a sender's perspective include the following: sender directed information about events that occurred during the mail unit processing; sender directed information about other mail units that are directly linked to the mail unit that is being served; sender directed information about objects directly linked to the mail unit being served; customer directed information about other mail communications, sent, received or replied by sender and recipient directed information about the mail unit; and customer service provider negotiated information defining remedies for instances when service could not be delivered as specified.

The sender may also specify rules expressing desired conditions imposed on physical and informational elements.

Regarding informational elements the customer may supply directed information about events in their corresponding attributes that occurred during mail unit processing. Information describing significant changes in values of attributes of the mail unit being served, including information concerning events as deposit, delivery, receipt, impossibility of delivery, mail unit damage or discarding information concerning defects of the mail unit obtained as a result postal processing including such attributes of mail unit as its digital image or digital image of its content.

The standard of evidence required from a sender's perspective may include defining the information security services for presentation of events information to the sender in both physical and electronic format. Evidence of the data origin authentication, data integrity and privacy may also be required.

The following are other examples of events from a senders perspective: depositing of the mal unit; delivery of the mail unit into recipients mailbox; delivery of the mail unit to the recipient; refusal of the mail unit by the recipient; forwarding of the mail unit to another party; diverting and sending the mail unit to another facility; returning the mail unit to the sender; and destroying the mail unit.

Informational elements customer directed information about other mail units that are directly linked to the mail unit that is being served. Information concerning the whereabouts of reply mail units that is mail items sent by the recipient of the given mail unit as a response to receiving it. Customer directed information about other objects directly linked to the mail unit being served. Information about the structure “building, post office box” identified in the destination address, information about intended or actual recipient of the mail unit.

Informational elements. Customer directed information about other mail communications sent, received or replied to by sender or recipient. Information how many directed mail units has been replied to by the recipient identified in the address block. Recipient directed information about the mail unit. Notification about up coming delivery or problems with delivery. Any invaluable to recipient information typically not available to sender at the time of mail unit creation. Customer service provider negotiated information defining remedies when service could not be delivered as specified. Insurance for lost items or refunds for late delivery in similar occurrences and events.

The following is an example of rules from a sender's perspective. If given mail unit cannot be delivered destroy it and send the digital image of the mail unit back to the sender.

If given mail unit cannot be delivered before this date/time, return mail unit and credit mailers account. If given mail unit is located in this facility, do not deliver it but send a digital image of the content and identity of the mail unit to this e-mail address. If given mail item unit is located in this facility after this date, send mail unit to different address. If given mail unit weighs less than the given value “e.g. 20 grams.” Send a digital image of the mail unit to the sender or notify the sender by electronically sending the mail unit identifier and the value of the attribute named for instance weight.

The following describes a postal product from a postal operator's perspective. The postal product contains physical elements, informational elements and rules, i.e., access requirements. The mail unit makeup “data elements, format emplacement” computerized information to accompany the mailing, its timing, messaging and protocol requirements. Grouping and containerization requirements i.e., presort and packaging rules. Pricing and payment requirements.

The term “mailer” refers to the mailer or parties acting on behalf of the mailer. Examples of tasks fulfilled by the mailer are: selection and creation of the mail units, printing the mail units, folding, inserting, franking, packing and induction of the mail units. The term “requirements” is derived from business needs and refers to desires or needs of the communicator i.e., delivery time for the communication, proof of delivery, costs, color and material of the mailing envelope and insert and the availability of the color and material of the mailing envelope and insert. The term “constraints” refers to a set of restrictions imposed on the physical composition of the mail units in terms of their attributes (names, values), i.e., location and size of address block, position and encoding scheme for the identifier,. Likewise, their may be constraints on sending and receiving information in electronic form to and from other parties, i.e., timing format protocols, etc.

The term “customer” refers to either mailer/sender or recipient or both depending on the context. When the meaning is not clear due to multiple possible contexts a clarification is used and either the term “mailer” or the term “recipient” are used. When a customer has decided to use a given carrier product (sometimes also referred to as a postal product), s/he is expected to download a file containing full description of the product (e.g. XML file) using any available public or private communication network or a media (e.g. CD-ROM). The aforementioned full description of the product contains among other things a complete set of instructions defining how a given product could be accessed. This means instructions as to how to create mail units or items satisfying carrier requirements, create and communicate any required by the carrier auxiliary information (e.g. mail manifest or a statement of mailing submission), payment information and the like as described above. The process of exchanging information between customers and carriers follows a communication protocol. This protocol if desired can be executed via secure channel in such a way that exchanged information can be protected for privacy, data integrity and source authentication and non repudiation. This allows to achieve all requirements necessary for treating computerized files representing carrier products as legally binding on both customers and service providers (carriers) and enables more effective dispute resolution when carrier products have not been delivered as has been expected by customers.

### BRIEF DESCRIPTION OF THE DRAWINGS

FIG. 1 is system diagram describing the carrier and mailer domains defined postal product s and services;

FIG. 2 is a flow chart describing the process utilized by computer 142 of FIG. 1,

FIG. 3 a flow chart describing how a mail unit receives a product and service that was requested in FIG. 2; and

FIGS. 4A and 4B is a flow chart depicting communication protocol (in a preferred embodiment) executed by customers and carriers with legally binding requirements of a commercial contract.

### DETAILED DESCRIPTION OF THE INVENTION

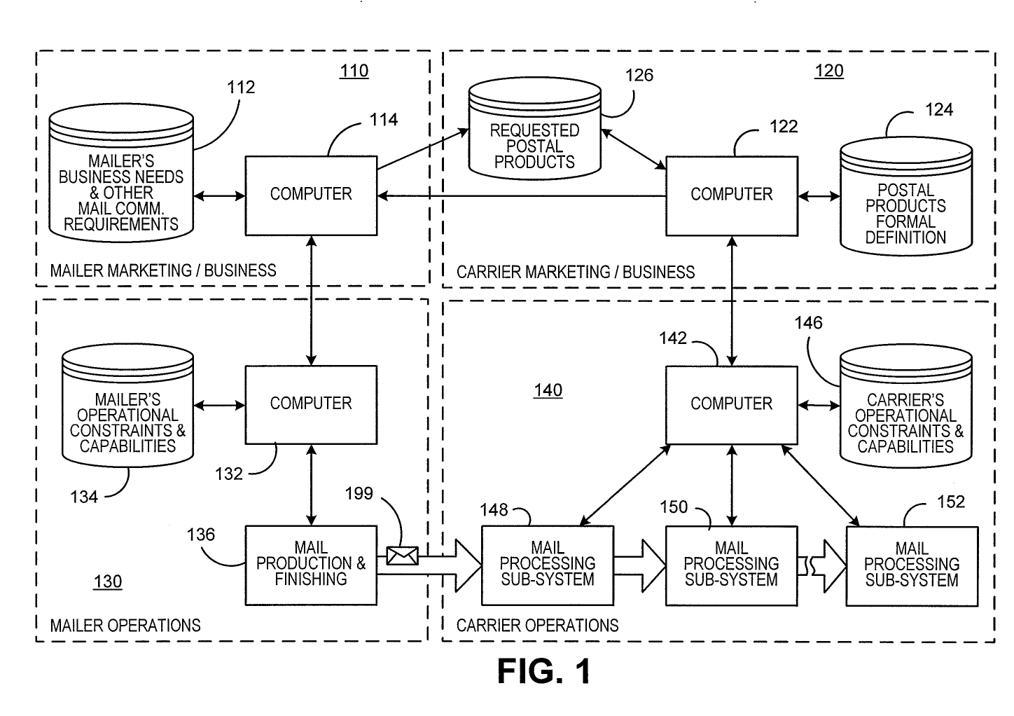

Referring now to the drawings in detail and more particularly to FIG. 1, the reference character 110 represents mailer's marketing and business operations. Mailer's marketing and business operations include mailer's business needs and other mail communications requirements data base 112 that contains formal computer processable information regarding the mailer's needs and other requirements and computer 114 that is coupled to data base 112. In some instances this information may be known only to human participants in customers environment such as business development or marketing professionals that control or own business applications with a distinct communication component. These may include Customer Relationship Management, Accounts Payable and Receivable, Tax, Investor Relations, Employee relations and the like. When mail communication requirements are formalized and stored in the data base 112 the process of selection of the product that optimally meets such requirements can be executed by a computer. Otherwise it involves a human participant with the knowledge of his/her desires and needs sufficient to make the optimal choice of the product. In both cases the selection is based on the product performance data that is stored in Carrier Product description File (CPF) and is amenable to both human and computer analysis and processing. It is also typical for human participants associated with marketing and business aspects to have little or no knowledge of postal products, their access requirements and limitations of customer' mail generation process. The CPF may typically contain such product performance data as delivery time (measured as time elapsed from established induction time to actual delivery of the mail unit), information concerning whereabouts of the mail unit at different stages of postal processing that can be made available to the customer, handling of various exceptional situations and the like. It is assumed that product performance data is sufficient for human or computer to select the product that meets customer' communication requirements in a best possible way. Mailer's operations 130 includes mailer's operational constraints and capabilities data base 134; computer 132 and mail production and finishing 136, that may include document and envelope printers, inserters, postage meters, etc. that produce mail unit 199. Computer 132 is coupled to data base 134, mail production and finishing 136 and computer 114. Database 134 contains formal computer processable information regarding the mailer's, constraints and capabilities i.e., a set of restrictions imposed on the physical composition of the mail units in terms of their attributes, i.e., location and size of address block, position and encoding scheme for the identifier, color and material of the mailing envelope and insert. Likewise, in database 104 there may be constraints on sending and receiving information in electronic form to and from other parties, i.e., timing format protocols, etc. It is assumed that customer's operations has complete knowledge of its own constraints and a sufficient understanding of product access requirements obtainable from CPF so, a determination can be made whether customer's operations can meet product access requirements or not. The process of such determination can be automated as described above or can be performed with the assistance and guidance from human professional. When product access requirements can not be met, the process produce list of discrepancies between mail generation and access requirements in specific areas related to mail production. These areas include physical constraints (PHC) of mail units (e.g. size, weight, material, content), informational constraints (INFC) (e.g. location, data content and data representation for address block or unit and product identifier, Statement of Mailing Submission etc.), Containerization Constraints (CONC) (e.g how mail units should be organized and packaged for a submission) and payment evidencing constraints (PAYC) (e.g. location, data content and data representation for digital postage marks or permit impressions). Mail unit 199 will enter mail processing sub-system 148.

Carrier marketing and business operations 120 includes mailer's requested postal products that do not currently exist but are desired by mailer's data base 126, computer 122 that is coupled to data base 126 and data base 124 that contains a formal description of carrier's products and services i.e., rules pertaining to what mail units may be sent and what they may contain, i.e., delivery time, area of collection and delivery, how sorted, read, print, unbundled, bundle, price, etc. Computer 122 is also coupled to computer 114 and computer 142 contained in post operations 140.

Post operations 140 also includes post's operational constraints and capabilities data base 146 that is coupled to computer 142, mail processing sub-system 148, mail processing sub-system 150 and mail processing subsystem 152. Mail processing sub-system 148, mail processing sub-system 150 and mail processing subsystem 152 are coupled to computer 142 and contain postal processing equipment, i.e., facer canceller, optical character recognition equipment, sorters, delivery equipment, etc.

The marketing department of a business may desire to enter new desired postal products and services into computer 114 which will be stored in data base 112. Some examples of new desired products and services are as follows. The mailer wants promotional invitations to be delivered to recipients around the country in exactly two days after the promotional mail units were inducted into by the post. The mailer wants the post to process mail units having round envelopes and/or having a particular color. The mailer wants the post to process mail units having art work, i.e., famous paintings printed over a defined portion of the face of the envelope. The mailer wants the post to track a plurality of business reply envelopes from the moment they are inducted by the post and the mailer wants to be notified by e-mail when the post processes the business reply envelopes. When desired by the mailer computer 114 will transmit the mailer desired new products and services stored in data base 112 to data base 126 Computer 122 collects the requests from data base 126 and communicates them to computer 142. Computer 142 communicates with data base 146 which contains of formalized description of the carrier operational constraints and capabilities and computer 142 then determines whether or not the post may be able to perform the new request.

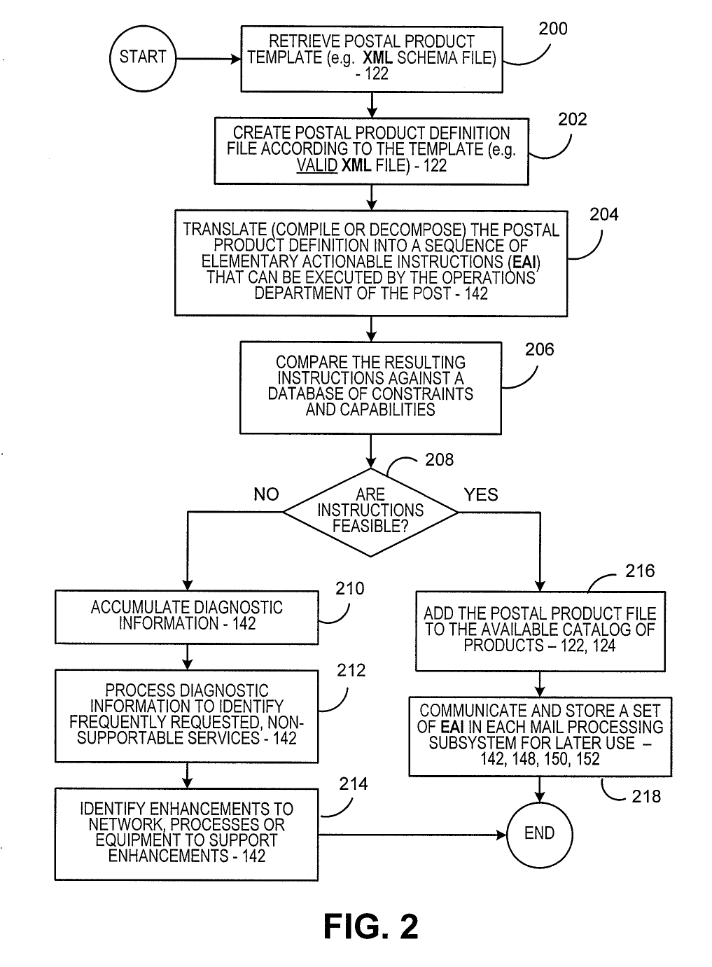

FIG. 2 is a flow chart describing the process utilized by computer 142 of FIG. 1. After the process starts the first step is step 200 where the post retrieves a postal product template, eg. XML schema file. It is customary for an XML schema file to use the extension XSD. We will refer to an XML schema file as an XSD file. The next step in the process is step 202 the creation of a postal product definition file according to the template, i.e., a valid XML file. Step 202 is driven by: the business needs of the post as set forth in data base 124 (FIG. 1). Data base 124 stores requests from mailers for specific products stored in data base 126 submitted to the post according to the postal product definition schema stored in computer 122 and data base 124. Next step 204 translates (compile or decompose) the postal product definition into a sequence of elementary actionable instructions (EAI) that can be executed by the operations department of the post.

The post operations department maintains a database 146 of posts capabilities and constraints that is retrieve by computer 142. Examples of constraints on both mail unit and postal processing subsystems are: limitations of barcode readability, limitation of transit time, pickup and delivery areas and time-of-day and thickness of an envelope for automated sorters. Examples of such elementary instructions are: identify the postal product requested for given mail unit; retrieve mail unit identity; read barcode (symbology, location), read radio frequency identification device (RFID), read handwritten text; measure mail unit dimensions, weight, color; retrieve the content of the Destination Address Block of the mail unit; modify the destination address information; transport mail unit; print identifier on mail unit (on the face/back, content, symbology, location); accept mail unit; deliver mail unit; sort mail unit; communicate exceptions, tracking information, issue refunds, extra charges; verify that the resulting instructions are feasible by comparing them against the database of constraints and capabilities; if successful, store validated XML file which represents the postal product; if failure, report the diagnostic information (inability of the network, process or equipment to perform requested EAI). The EAI is also communicated and stored in each mail processing subsystem for later use, i.e., computer 142 (FIG. 1), and sub-systems 148, 150, and 152

At this point step 206 compares the resulting instructions against data base 146 (FIG. 1) constraints and capabilities, i.e., can the post process round envelopes. The next step in the process is step 208. Step 208 determines whether or the instructions are feasible. If step 208 determines that the instructions are not feasible the next step is step 210. Step 210 accumulates diagnostic information in computer 142. Next step 212 processes the diagnostic information to identify frequently requested, non-supportable services and stores the result in computer 142. Then step 214 identifies the enhancements to the network, processes or equipment to support the enhancements. In other words step 214 informs the post of changes that may be made to their sub-systems to make new products and services possible.

If step 208 determines that the instructions are feasible the next step is step 216. Step 216 adds the postal product file to the available catalog of products controlled by computer 122 and stored in data base 124. Then step 218 communicates and stores a set of EAI in computer 142 and in mail processing sub-systems 148, 150 and 152 for later use. After completing step 214 or step 218 the process ends.

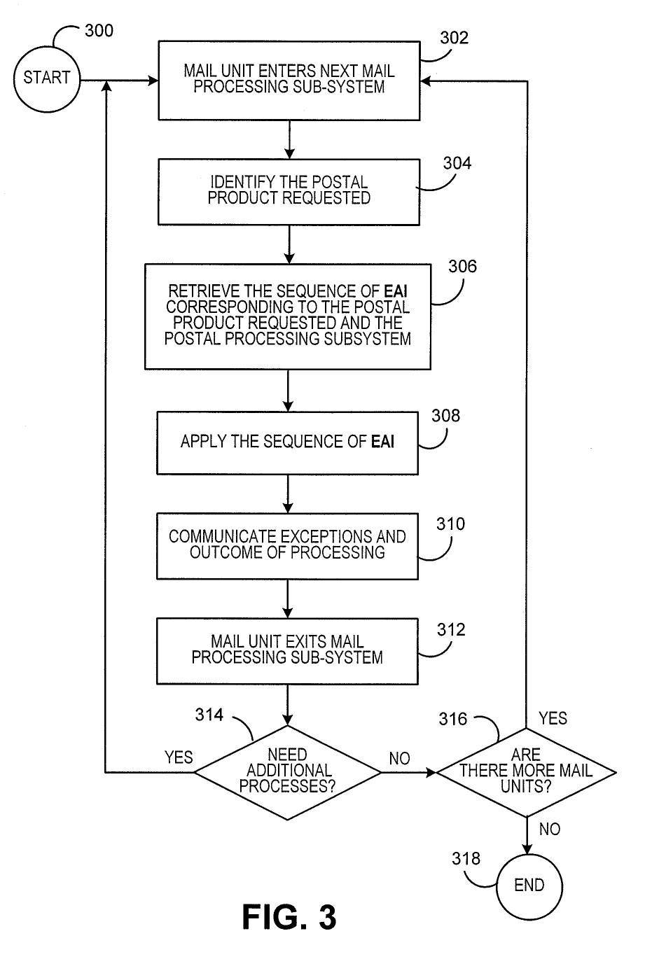

FIG. 3 a flow chart describing how a mail unit receives a product and service that was requested in FIG. 2. At step 300 Start, at step 302 Mail unit enters next mail processing sub-system, step 304 identify the postal product request, step 306 Retrieve the sequence of EAI corresponding to the postal product requested and the postal processing subsystem, step 308 Apply the sequence of EAI, at step 310 Communicate exceptions and outcome of processing, step 312 Mail unit exits mail processing sub system, step 314 Need additional processes?, step 316 Are there more mail units, Step 318 end.

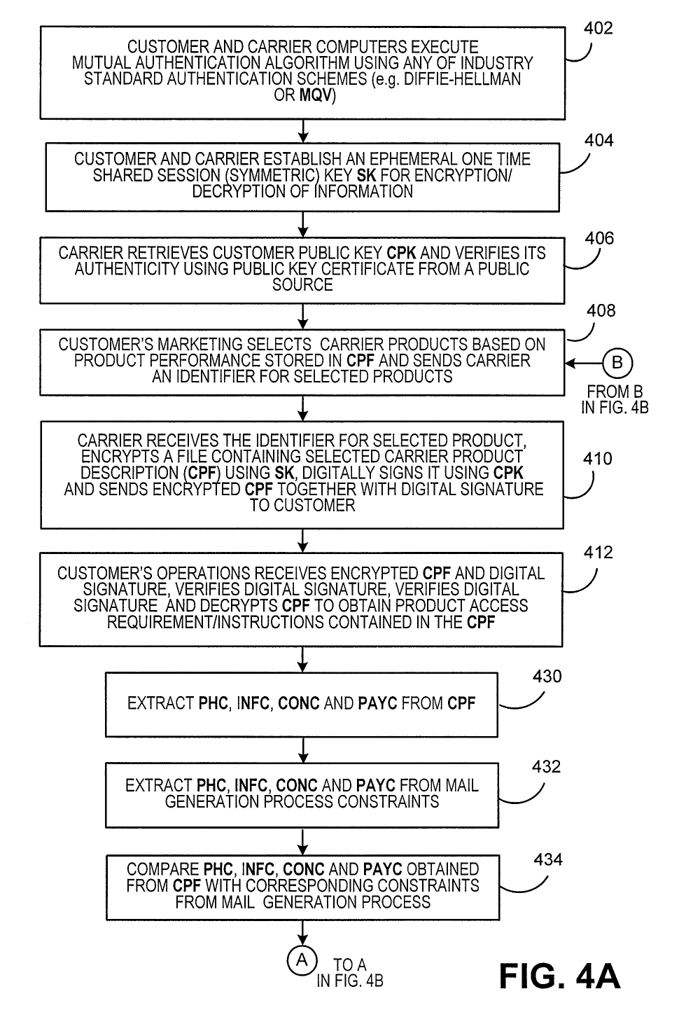

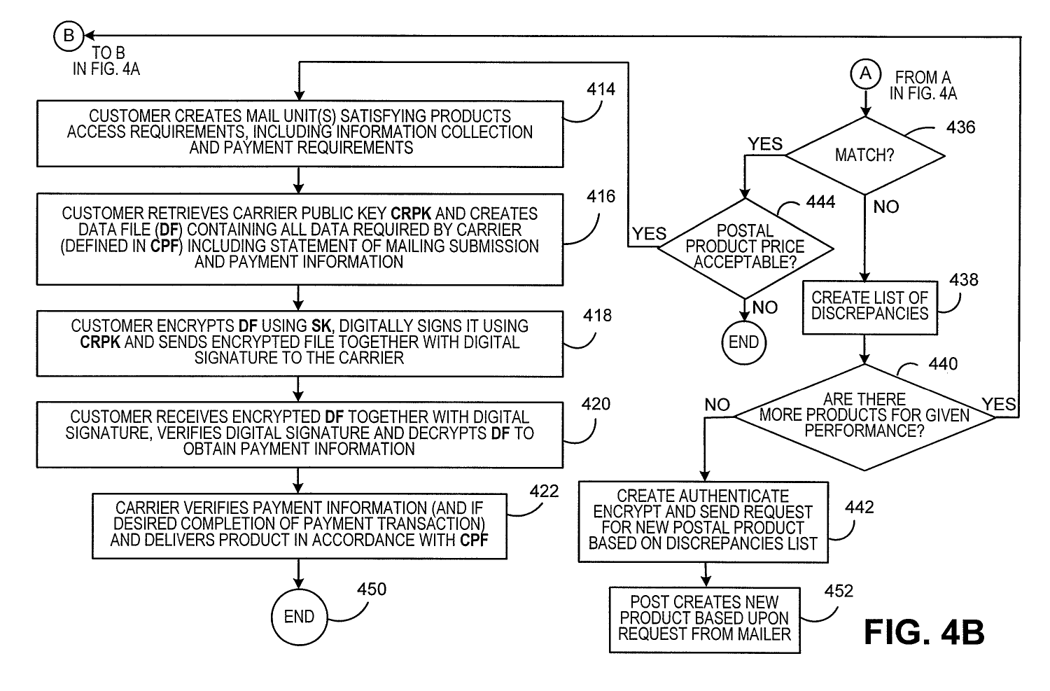

FIG. 4. is a flow chart depicting communication protocol (in a preferred embodiment) executed by customers and carriers with legally binding requirements of a commercial contract. The protocol begins in step 402, where the Customer and the Carrier' computers execute mutual authentication algorithm using any of the industry standard authentication schemes (e.g. Diffie-Hellman or MQV). Next in step 404 the Customer and the Carrier establish an ephemeral one time shared (symmetric) session key SK for encryption/decryption of information. At 406 the Carrier retrieves customer public key CPK from any suitable sources (such as Public Key Infrastructure) and verifies its authenticity using public key certificate from a trusted source. Then in step 408 the Customer marketing selects carrier products based on product performance stored in CPF and sends the carrier an identifier for the selected products. At step 410 the Carrier receives the identifier for the selected product, encrypts a file containing selected carrier product description (CPF) using SK, digitally signs it using CPK and sends the encrypted CPF together with its digital signature to the Customer. Now at step 412 the Customer's operation receives the encrypted CPF and the digital signature, verifies the digital signature and decrypts CPF using SK to obtain product access requirement/instructions contained in the CPF.

Next in step 430 the PHC, INFC, CONC and PAYC are extracted from the CPF. Then step 432 extracts the PHC, INFC, CONC and PAYC from mail generation process constraints. Now in step 434 the PHC, INFC, CONC and PAYC obtained from the CPF is compared with the corresponding constraints from the mail generation process constraints. The next step is step 436. Step 436 determines whether or not the PHC, INFC, CONC and PAYC obtained from the CPF match the constraints obtained from the mail generation process. If step 436 determines that the PHC, INFC, CONC and PAYC obtained from the CPF match the constraints obtained from the mail generation process, the next step is step 444. Step 444 determines whether or not the postal product price is acceptable to the customer. If step 444 determines that the postal product price is not acceptable to the customer the process ends. If step 444 determines that the postal product price is acceptable to the customer the process goes to step 414.

In step 414 the Customer creates mail unit(s) satisfying products access requirements, including information collection and payment requirements. Then in step 416 the Customer retrieves the carrier public key CRPK and creates a Data File (DF) containing all data required by the Carrier (defined in the CPF) including a Statement of Mailing Submission and payment information. At step 418 the Customer encrypts DF using SK, digitally signs it using CRPK and sends the encrypted file together with its digital signature to the Carrier. Then at step 420 the Customer receives encrypted DF together with its digital signature, verifies the digital signature and decrypts DF to obtain payment information. Now at step 422 the Carrier verifies payment information (and if desired completion of a payment transaction) and delivers product in accordance with the CPF. Then in step 450 the process ends.

If step 436 determines that the PHC, INFC, CONC and PAYC obtained from the CPF do not match the constraints obtained from the mail generation process, the next step is step 438. In step 438 a list of discrepancies is created. Next step 440 determines whether or not there are more products for the given performance. If step 440 determines that there is an additional product for the given performance the process goes to step 408. If step 440 determines that there no additional product for the given performance the process goes to step 442. Then step 442 creates, authenticates, encrypts and sends a request for new postal products based on the discrepancies list. All information coming from the customer's environment concerning requests for new products is private to the customer because it contains limitations regarding the customers' equipment which may be subject to proprietary contractual clauses of the contract between the customer and its equipment supplier. The customers' information may also be confidential because it reflects capabilities of the customers' mailing operation, business needs and other proprietary information. At this point the process goes to sep 452 where the post creates a new product or products based upon requests from the mailer.

As can be seen from the foregoing description, the protocol of FIG. 4 enables a legally binding contract on both the Customer and the Carrier. Specifically all conditions and remedies for different contingencies encoded in the CPF could not be misinterpreted and mistreated (unless deliberately) without detection by the injured party due to non-repudiation and data integrity properties of digital signatures. Also the protocol of FIG. 4 meets data privacy requirements when data exchanged between customers and carriers must be protected due to competitive or other reasons. This enables a very effective private communications of carrier products files and corresponding information collected by customers between carriers and customers.

The above specification describes a new and improved method for automating the creation of new postal products and the modification of existing postal products. It is realized that the above description may indicate to those skilled in the art additional ways in which the principals of this invention may be used without departing from the spirit. Therefore, it is intended that this invention be limited only by the scope of the appended claims.

What is claimed is:

1. A method for selecting postal products by a mailer, utilizing a computer to perform the steps of:
obtaining carrier product descriptions;
selecting a candidate carrier product based upon the carrier product descriptions;
extracting from the candidate carrier product descriptions access requirements;
extracting mail generation process constraints;
comparing the candidate carrier product access requirements and the mail generation process constraints;
determining that there is no candidate carrier product that matches the candidate carrier product access requirements and the mail process generation constraints; and
creating a record of discrepancies between the candidate carrier product access requirements and the mail process generation constraints.

2. The method claimed in claim 1, further including the step of:
receiving by the mailer a new product carrier description obtained from a carrier based upon the record of discrepancies.

3. The method claimed in claim 2, wherein the new carrier product description contains new product access requirements.

4. The method claimed in claim 3, wherein the mailer produces new mail units according to the new product access requirements.

5. The method claimed in claim 1, wherein the carrier product description is digitally signed and encrypted.

6. The method claimed in claim 5, further including the step of: verifying authenticity and data integrity of the carrier product description using digital signature verification.

7. The method claimed in claim 1, further including the step of: protecting carrier product description by encryption.

8. The method claimed in claim 1, further including the step of: resolving disputes using the carrier product description.

9. The method claimed in claim 8, wherein the carrier product description is a legally binding instrument

10. The method claimed in claim 1, wherein access requirements are physical constraints of a mail unit.

11. The method claimed in claim 10, wherein the physical constraints of the mail unit are selected from the group consisting of size, weigh, material, and content of the mail unit.

12. The method claimed in claim 1, wherein access requirements are informational constraints of a mail unit.

13. The method claimed in claim 12, wherein the informational constraints of the mail unit are selected from the group consisting of data content appearing on a face of the mail unit and mail unit delivery identifiers.

14. The method claimed in claim 1, wherein the mail generation constraints are capabilities of the mailer to prepare a mail unit.
